(19) United States
(12) Patent Application Publication
(10) Pub. No.: US 2024/0104314 A1
(43) Pub. Date: Mar. 28, 2024

(54) Object, Detection System and Method for Detecting an Object on a Capacitive Tough Sensor

(71) Applicant: Siemens Aktiengesellschaft, Muenchen (DE)

(72) Inventor: Diego Gerardo LOPEZ PADILLA, Nürnberg (DE)

(21) Appl. No.: 18/275,461

(22) PCT Filed: Dec. 17, 2021
(86) PCT No.: PCT/EP2021/086573

§ 371 Date: Aug. 2, 2023

(30) Foreign Application Priority Data
Feb. 4, 2021 (EP) 21155252

(51) Int. Cl. G06K 7/08

(52) U.S. Cl. CPC G06K 7/081

(57) ABSTRACT

A method for detecting an object on a capacitive touch sensor of an operating terminal, wherein the object has an identifier that provides, whereby detectable information, where the identifier is detected as touch sensor data via the touch sensor and the touch sensor data is forwarded to an analysis unit, where the information of the identifier is ascertained in the analysis unit using the touch sensor data and the identifier comprises a marking, made of a conductive material, which has shapes that are connected by a connecting line, where the object is placed on the touch sensor such that the marking lies flat on the touch sensor that detects the shapes as contact points, and where the arrangement of the shapes and thus the detected contact points, provides the information.

### CROSS-REFERENCE TO RELATED APPLICATIONS

This is a U.S. national stage of application No. PCT/EP2021/086573 filed 17 Dec. 2021. Priority is claimed on European Application No. 21155252.6 filed 4 Feb. 2021, the content of which is incorporated herein by reference in its entirety.

### BACKGROUND OF THE INVENTION

### 1. Field of the Invention

The invention relates to a method for detecting an object on a capacitive touch sensor of an operating terminal, where the object has an identifier via which detectable information is provided, where the identifier is detected as touch sensor data via the touch sensor and the touch sensor data is forwarded to an evaluation unit, wherein the information of the identification means is ascertained in the evaluation unit on the basis of the touch sensor data.

The invention also relates to an object configured for placement on a capacitive touch sensor of an operating terminal, comprising an identifier that is configured to provide detectable information for the touch sensor.

Furthermore, the invention relates to a detection system having an operating terminal with a capacitive touch sensor and an object.

### 2. Description of the Related Art

According to customary expert knowledge, RFID, QR codes and barcodes are known in the prior art for object detection. QR codes and barcodes are drawn, for example, over a scanner register, such as in supermarkets when purchasing food, where the object being purchased is detected by its ID and can be automatically entered in a register. RFID technology, in particular Near Field Communication (NFC) has already established itself as a popular form of payment method.
EP 2 722 789 A2 discloses a sensor arrangement for detecting a data carrier on a touch screen.
EP 2 635 996 B1 discloses a capacitive surface sensor, which makes it possible to detect a “touch structure” of objects.

### SUMMARY OF THE INVENTION

It is an object of the invention to provide a method and system that improves upon conventional object detection methods and apparatuses.

This and other objects and advantages are achieved in accordance with the invention by a method for detecting an object on a capacitive touch sensor of an operating terminal in which the identifier comprises a marking produced from a conductive material, and the marking has shapes, which are connected by a connecting line, where the object is placed on the touch sensor such that the marking lies flat on the touch sensor, and the touch sensor thereby detects the shapes as touch points, and where the arrangement of the shapes and thereby the detected touch points reproduces the information.

In accordance with the method of the invention, an algorithm is executed (run) in the evaluation unit, where the algorithm learns the object detection based on the touch sensor data and stores detected objects, and where the algorithm is executed to ascertain a characteristic relationship of the touch points to each other such that it is possible to detect the identifier means or its detectable information based on the characteristic relationship at any location on the touch sensor.

The introduced artificial intelligence or the algorithm, which runs in the evaluation unit, could be supported by neural networks or by self-organizing maps, which learn the patterns and store them in the map. Self-organizing maps denote a type of artificial neural network, which are capable of using a supervised leaning method.

Preferably, touch points are now simulated using the shapes contained in the marking, where the points normally occur on the touch screen due to touching by the finger. The shapes, which emulate the touch points, contained in the marking are in a particular relationship/relation to each other. As a result, it is possible to derive the information from this typical, clear pattern.

It is advantageous, moreover, if the objects have one contact point respectively, and this contact point is touched by part of a human hand of an operator when the object is laid flat on the touch sensor. In particular, in the case of touch sensors having a sensitivity to multi-touch capture that is not very pronounced, it can be helpful if the marking, and therewith the shapes connected by connecting lines, which are preferably made of a conductive ink, are simultaneously connected to a human hand via a contact point. The capacity of a human body is sufficient, even in the case of touch screens that are not so sensitive, to then detect the pattern of the marking.

The method can advantageously be used with an operating terminal, which manages a user detection and the detection of an object is evaluated as an authentication of a user.

It is also conceivable to use the method for a product detection, where the operating terminal is configured to manage a product ascertainment and the detection of the object is used to ascertain a product, and where the detected information is evaluated as a product code.

Compared with a known QR code, it is particularly advantageous in accordance with the method of the invention if a conductive ink is used for the conductive material of the marking, preferably an invisible conductive ink is used. It is thus no longer possible to simply photograph the QR code as previously.

An object is configured for placement on a capacitive touch sensor of an operating terminal, comprising an identifier that is configured to provide detectable information for the touch sensor. The identifier includes a marking having a conductive material, which marking has shapes, which are connected by a connecting line, where the object has at least one surface in which the marking is arranged.

In the case of the object, one side is, for example, configured so as to be flat, so this surface can be placed on a touch sensor, where the marking then rests flat on the touch sensor, and the shapes can be detected by the touch sensor thereby. In a first variant the object can be configured as an ID card, check card or service card with which a user can register or identify themselves at an operating terminal.

In an embodiment, the object can be configured as a flyer, where the marking with the conductive ink would then be invisibly integrated on or in the flyer and a flyer could be placed on the touch screen and there is thus extensive information about the flyer via the operating terminal.

In another embodiment, the object can be integrated in secondary packaging of a product and thus can be registered by a touch sensor via a register system.

To increase the sensitivity in the object for registering on the touch sensor, an object is configured with a contact point, and this contact point is configured to be touched by a human hand of an operator. This has the advantage that a capacity of a human body, which lies, for example, in the region of 100 pF to 300 pF, can be utilized.

It is also an objection of the invention to provide a detection system having an operating terminal with a capacitive touch sensor, where an object for placement on the touch sensor is used for detection. The object is configured for placement on the touch sensor and it has an additional identifier, which is in turn configured to provide detectable information for the touch sensor. The identifier includes a marking having a conductive material, which marking has shapes, which are connected by a connecting line, where the object has at least one surface in which the marking is arranged. The touch sensor is also configured to ascertain the identifier as touch sensor data when the object is placed on the touch sensor and the marking lies flat on the touch sensor, and the touch sensor thereby detects the shapes as touch points. An evaluation unit is present, moreover, which ascertains the information based on the touch sensor data, where the evaluation unit ascertains the information based on the detected touch points.

The detection system has an algorithm, which is executed (run) in the evaluation unit. This algorithm will learn the object detection based on the touch sensor data and store detected objects, where the algorithm is executed such to ascertain a characteristic relationship of the touch points to each other such that it becomes possible to detect the identifier or it detectable information based on the characteristic relationship at any location on the touch sensor.

In a continuative embodiment, the detection system is expanded to the extent that the objects have one contact point respectively, and this contact point is touched by part of a human hand of an operator when the object is placed flat on the touch sensor.

With regard to a user identification for an industrial system, the detection system is advantageously configured such that the operating terminal has a user detector in order to manage a user detection and to evaluate the detection of an object as an authentication of a user.

With regard to a future register system or a product ascertainment in manufacturing, the detection system is advantageously configured such that the operating terminal has a product-ascertainer to manage a product ascertainment and the detection of the object is used to ascertain a product, where the detected information is evaluated as a product code.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawings show one exemplary embodiment of the invention, in which:

FIG. 1 shows an embodiment having an object made of conductive ink in accordance with the invention;

FIG. 2 shows a an embodiment of a further object having conductive ink in accordance with the invention;

FIG. 3 shows yet a further embodiment of an object in accordance with the invention;

FIG. 4 shows a detection system having an operating terminal in accordance with the invention;

FIG. 5 shows a touch screen that has been let into a conveying route in accordance with the invention; and

FIG. 6 is a flowchart of the method in accordance with the invention.

### DETAIL DESCRIPTION OF THE EXEMPLARY EMBODIMENTS

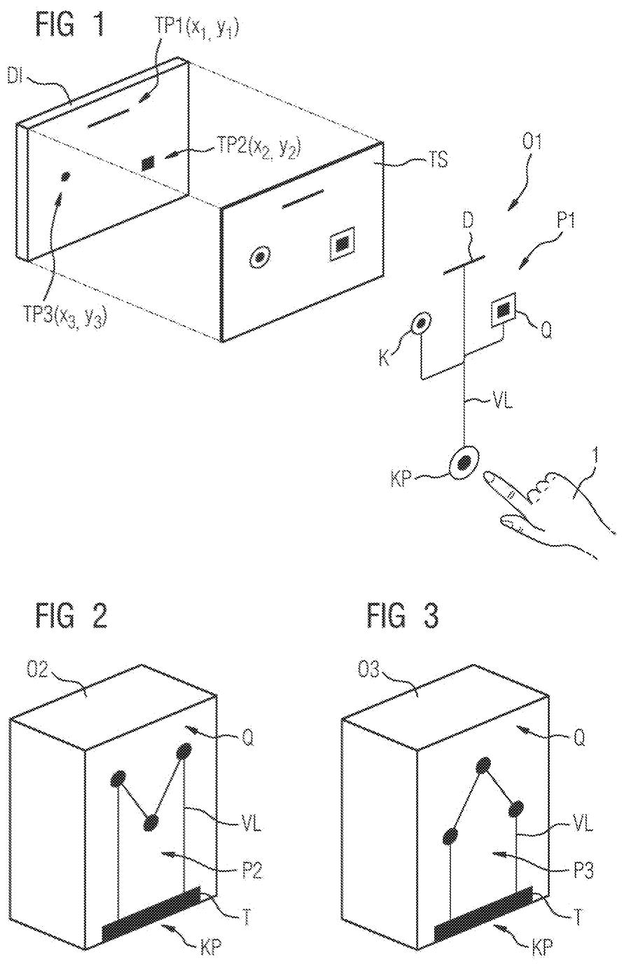

With reference to FIG. 1, a display DI, a touch sensor TS and a first object O1 is represented in a perspective exploded view. The display DI is configured, for example, as an LC display and the touch sensor TS is configured as a capacitive multi-touch sensor. The object O1 is schematically represented and has a first marking P1 made of a conductive material. The marking P1 has shapes K, Q, D, which are connected by a connecting line VL. The marking P1 is connected by its connecting line VL to a contact point KP. When the first object O1 lies flat on the touch sensor TS, the contact point KP serves for touching by a human hand 1 of a user.

The touch sensor TS registers placement of a first touch point TP1 with first touch coordinates x₁, y₁. The first touch point TP1 is generated by the first shape D. Furthermore, the touch sensor TS registers a second touch point TP2 with the touch coordinates x₂, y₂. The second touch point TP2 is generated by the shape Q. The shape K produces a third touch point TP3 with the touch coordinates x₃, y₃ on the touch sensor TS.

The human hand 1 touching the contact point KP serves to intensify the capacitive signal because the natural capacity of the human body is utilized.

Inventively, the principle that an identifier made of a conductive material is arranged in an object O1 is utilized. In this case, a first marking P1 made of a conductive ink has been represented. The conductive ink maps shapes K, Q, D, which are interconnected by a connecting line. When the first object O1 is laid flat on the touch sensor TS, touch points TP1, TP2, TP3 can thereby be detected by the touch sensor TS, with the coordinates x₁, y₁; x₂, y₂; x₃, y₃ of the touch points TP1, TP2, TP3 reproducing the information ID of the object O1.

The touch points TP1, TP2, TP3 have a particular relationship or relation to each other. Accordingly, this clear relation can also be used to again detect the information at any locations on the touch screen TS.

FIG. 2 shows one possible embodiment of an object in a schematic three-dimensional view. A second object O2 is configured, for example, as a cuboid and a second marking P2 made of a conductive ink is mapped on a base area G. The second marking P2 has substantially three circles, which are connected together by the connecting line VL and the contact point KP.

With reference to FIG. 3, shown therein is a third object O3, with the third object O3 also being configured as a cuboidal object having a base area G. The applied third marking P3 made of the conductive ink has a different information structure to the second marking P2 represented in FIG. 2 and can thus be used for different information or identity.

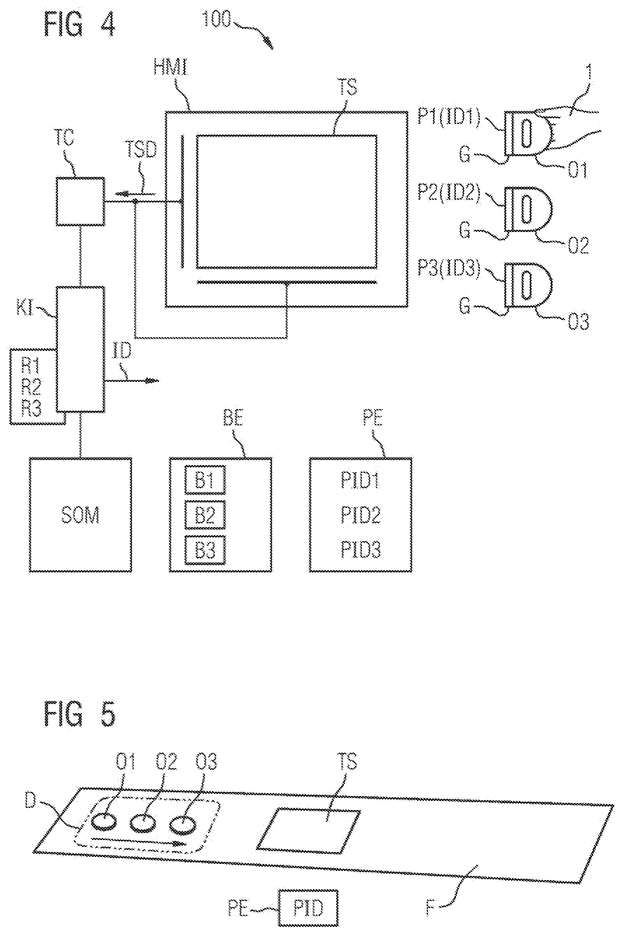

FIG. 4 shows a representation of a detection system 100. The detection system 100 includes an operating terminal HMI having a capacitive touch sensor TS. A user has a first object O1, a second object O2 and a third object O3 available in order to detect objects O1, O2, O3 with the touch sensor TS. A user can grasp, for example, the first object O1 with their human hand 1, and press against the touch sensor TS with the base area G of the first object O1. With a touch controller TC, the touch sensor TS is configured to detect the first marking P1 or the identifier contained therein. The first marking P1 is a structure drawn with conductive ink, with especially striking shapes K, Q, D (see FIG. 1) being detected on the touch sensor TS as touch points. When the first object O1 is placed on the touch sensor TS and the first marking P1 lies flat on the touch sensor PS, the touch sensor TS can thereby detect the shapes K, Q, D as touch coordinates x₁, y₁, x₂, y₂, x₃, y₃. The touch sensor TS now sends touch sensor data TSD, which contains the information ID, to an evaluation unit KI via the touch controller TC. The evaluation unit KI can detect the information ID, which is contained in the first object O1, based on the detected touch points TP1, TP2, TP3 or its touch coordinates x₁, y₁, x₂, y₂, x₃, y₃.

The evaluation unit KI is developed, in particular with a neural network, to execute (run) an algorithm AG, which makes it possible to ascertain a characteristic relationship R1, R2, R3 of the captured touch points TP1, TP2, TP3 to each other from a detected object O1, O2, O3, whereby it is possible that the identifier or its detectable information ID can be detected based on the characteristic relationship R1, R2, R3 at any location on the touch sensor TS.

The first object O1 thus reproduces a characteristic relationship R1 with the first marking P1, the second object O2 reproduces a second characteristic relationship R2 with the second marking P2 and the third object O3 reproduces a third characteristic relationship R3 with the third marking P3. A self-oriented neural map SOM can also be connected to the evaluation unit KI in support of a detection and learning method.

When the detection system 100 is used for a user detection, the operating terminal HMI thus also has a user detector BE in order to manage a user detection and to evaluate the detection of an object O1, O2, O3 as an authentication of a user.

When the detection system 100 is used for a product ascertainment, the operating terminal HMI thus has a product-ascertainer PE in order to manage a product ascertainment and the detection of the object O1, O2, O3 is used to ascertain a product P, with the detected information ID being evaluated as a product code PID.

With reference to FIG. 5, an exemplary conveying system F is represented on which various products P in the form of a first object O1, a second object O2 and a third object O3 are conveyed in the direction of the arrow. The products P are then guided one after the other over the touch sensor TS, where it is possible to detect with the aid of the detection system 100, represented by FIG. 4, in product ascertainment mode the product IDs PID of the individual products P or objects O1, O2, O3 respectively.

Further embodiments of the invention are as follows: with a pattern having transparent conductive ink, it is possible to identify a unique pattern with artificial neural networks because the pattern is simultaneously pressed with the hand against a multi-touch screen. The capacity of the human body can also be used. With the possibility of detecting unique patterns, the disclosed embodiments of the invention opens the door to new possibilities for identifying objects more reliably, effectively and cheaply than conventional systems, such as RFID, QR codes and barcodes.

To achieve reliable detection of a pattern, it is necessary to make it possible for the users to freely scan a conductive pattern without having to localize the conductive color wheel pattern in a particular x- and y-coordinate of the multi-touch screen. An artificial neural network can be used for this to make it possible to detect a plurality of patterns in any x- and y-coordinate.

There are many applications that can be accomplished with the embodiments of the invention. In the case of the applications, it should be observed that the conductive ink adheres to or is printed on, for example, boxes, ID cards, or product booklets.

a) Production Article Tracking

The user scans an article (for example, factory article, Amazon delivery box, medicine box, or book) and the system is capable of finding the description of the specific article, such as where and when it was produced. This application is also practical for article recording and data completion operations. If, for example, a delivery box of a device is scanned, then the system displays its serial number, hardware specification and firmware version as well as the operating instructions.

b) Authentication

By scanning an ID card, the user can access their data and receives their relevant information, such as what are the next objects, and/or production line results.

c) Digital Access

The system can open a particular website, such as a user handbook PDF, contact information page, feedback form, and/or card location, in that it scans an article, such as a product booklet, a flyer, or a business card. If a device has GPS or other sensors, then these can be used to improve the user experience, for example a mobile device can open the card App with the route to a favorite site.

d) Personalized Card Request

Particular cards having programmed actions, which have a particular objective, can be used, for example, by scanning a support card the system knows who and where a user has scanned a card and can inform the entity responsible for this specific operating line.

Advantages:
Normally a factory has displays but no keyboards or pointer devices. None of these are necessary for the method in accordance with the embodiments of the invention, and this makes the interaction with the system faster.
When other sensors, such as GPS, which are contained in mobile devices, are used a user can save time because they find routes to particular objectives.
Reducing the time for manually inputting information into the system. The disclosed embodiments of the invention can simultaneously trigger actions and query data, which are assigned to an individual pattern.
Reducing the time for manually searching for system data, such as opening an App, logging in/out, starting/stopping a run-time.
The data is displayed immediately on the same screen on which a scanned process has taken place, whereby the operating time is reduced and this also improves the user experience according to the WYSIWYG principle (What You See Is What You Get).
No additional hardware is necessary because any multi-touch display can be used, including old industry displays, mobile devices or tablets.
The costs for this system are lower than in the case of RFID sensors and tags because no additional sensor and tags are necessary.
The costs for the conductive ink system presented here are also lower than in the case of QR codes because no camera is required.
The system can be implemented using web technologies (JavaScript), which are executed in any web browser. This makes the implementation cross-platform.
The conductive patterns can be printed using conventional printers, so every wish can be integrated intuitively and quickly.
The disclosed embodiments of the invention make it possible to trigger actions, such as informing other systems, starting/stopping machines, starting/stopping a run-time, increasing/reducing the tag values of sensors, and/or calls.
By using a transparent conductive ink, the setup patterns can be placed on surfaces without affecting other representations.

Security:
The interaction of a person is necessary for the method in accordance with the disclosed embodiments of the invention to work.
A QR code system can simply be photographed and be shared over the Internet in order to be accessible to anyone. There is no possibility of doing this with the method in accordance with the disclosed embodiments of the invention.
An RFID system can be triggered without a person's consent. This is not possible with the method in accordance with the disclosed embodiments of the invention.
A transparent conductive ink is provided to avoid a replication of the patterns.

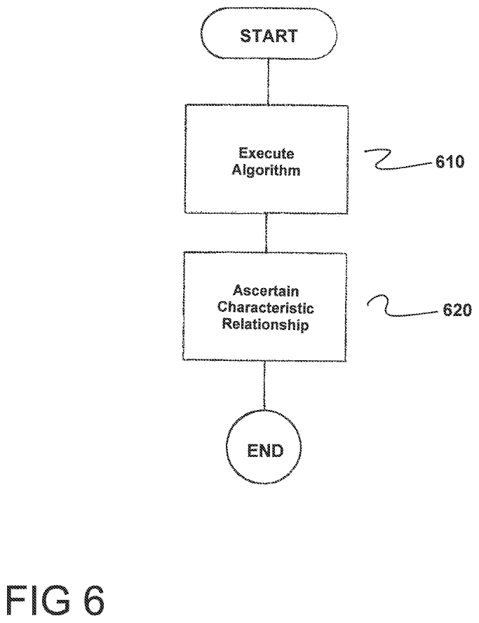

FIG. 6 is a flowchart of the method for detecting an object O1, O2, O3 on a capacitive touch sensor TS of an operating terminal HMI, where the object O1, O2, O3 has an identifier via which detectable information ID is provided, where the identifier is detected as touch sensor data TSD via the touch sensor TS, where the touch sensor data TSD is forwarded to an evaluation unit KI, the information ID of the identifier being ascertained in the evaluation unit KI based on the touch sensor data TSD. In accordance with the method of the invention, the identifier comprises a marking P1, P2, P3 produced from a conductive material, where the marking P1, P2, P3 has shapes K, Q, D that are connected by a connecting line VL, where the object O1, O2, O3 is placed on the touch sensor TS such that the marking P1, P2, P3 lies flat on the touch sensor TS, the touch sensor TS thereby detect the shapes K, Q, D as touch points x₁, y₁, x₂, y₂, x₃, y₃, and where arrangement of the shapes K, Q, D and therewith detected touch points x₁, y₁, x₂, y₂, x₃, y₃ reproducing the information ID.

The method comprises executing an algorithm AG in the evaluation unit KI, said algorithm learning the object detection based on the touch sensor data TSD and storing detected objects O1, O2, O3, as indicated in step 610.

Next, the algorithm AG is executed to ascertain a characteristic relationship R of the touch points x₁, y₁, x₂, y₂, x₃, y₃ to each other such that the identifier or detectable information ID based on the characteristic relationship R1, R2, R3 at any location on the touch sensor TS is detectable, as indicated in step 620.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A method for detecting an object on a capacitive touch sensor of an operating terminal, the object having an identifier via which detectable information is provided, the identifier being detected as touch sensor data via the touch sensor, the touch sensor data being forwarded to an evaluation unit, the information of the identifier being ascertained in the evaluation unit based on the touch sensor data, the identifier comprising a marking produced from a conductive material, the marking having shapes which are connected by a connecting line, the object being placed on the touch sensor such that the marking lies flat on the touch sensor, the touch sensor thereby detecting the shapes as touch points, and arrangement of the shapes and therewith detected touch points reproducing the information, the method comprising:
executing an algorithm in the evaluation unit, said algorithm learning the object detection based on the touch sensor data and storing detected objects; and
executing the algorithm to ascertain a characteristic relationship of the touch points to each other such that the identifier or detectable information based on the characteristic relationship at any location on the touch sensor is detectable.

11. The method as claimed in claim 10, wherein the objects have one contact point respectively, said contact point being touched by part of a human hand of an operator when the object is laid flat on the touch sensor.

12. The method as claimed in claim 10, wherein the operating terminal is configured to manage a user detection and to evaluate the detection of an object as an authentication of a user.

13. The method as claimed in claim 11, wherein the operating terminal is configured to manage a user detection and to evaluate the detection of an object as an authentication of a user.

14. The method as claimed in claim 10, wherein the operating terminal is configured to manage a product ascertainment and the detection of the object is utilized to ascertain a product; and wherein the detected information is evaluated as a product code.

15. The method as claimed in claim 11, wherein the operating terminal is configured to manage a product ascertainment and the detection of the object is utilized to ascertain a product; and wherein the detected information is evaluated as a product code.

16. The method as claimed in claim 12, wherein the operating terminal is configured to manage a product ascertainment and the detection of the object is utilized to ascertain a product; and wherein the detected information is evaluated as a product code.

17. The method as claimed in of claim 10, wherein a conductive ink serves as the conductive material of the marking.

18. A detection system comprising:
an operating terminal including a capacitive touch sensor;
an object;
wherein the object is formed to be placed on the touch sensor and include an identifier which is configured to provide detectable information for the touch sensor, the identifier including a marking having a conductive material, which has shapes, which are connected by a connecting line, and the object including at least one surface in which the marking is arranged;
wherein the capacitive touch sensor is configured to ascertain the identifier as touch sensor data when the object is placed on the touch sensor and the marking lies flat on the touch sensor, the touch sensor thereby detecting the shapes as touch points;
an evaluation unit which ascertains the information based on the touch sensor data, the evaluation unit ascertaining the information based on the detected touch points;
wherein an algorithm is executed in the evaluation unit, said algorithm learning the object detection based on the touch sensor data and storing detected objects; and
wherein the algorithm is executed to ascertain a characteristic relationship of the touch points to each other such that the identifier or detectable information based on the characteristic relationship at any location on the touch sensor is detectable.

19. The detection system as claimed in claim 18, wherein the objects have one contact point respectively, said contact point being touched by part of a human hand of an operator when the object is laid flat on the touch sensor.

20. The detection system as claimed in claim 18, wherein the operating terminal has a user detector which manages a user detection and evaluates the detection of an object as an authentication of a user.

21. The detection system as claimed in claim 19, wherein the operating terminal has a user detector which manages a user detection and evaluates the detection of an object as an authentication of a user.

22. The detection system as claimed in claim 18, wherein the operating terminal includes a product-ascertainer which manages a product ascertainment and the detection of the object is utilized to ascertain a product; and wherein the detected information is evaluated as a product code.

23. The detection system as claimed in claim 19, wherein the operating terminal includes a product-ascertainer which manages a product ascertainment and the detection of the object is utilized to ascertain a product; and wherein the detected information is evaluated as a product code.

24. The detection system as claimed in claim 20, wherein the operating terminal includes a product-ascertainer which manages a product ascertainment and the detection of the object is utilized to ascertain a product; and wherein the detected information is evaluated as a product code.
